(19) United States
(12) Patent Application Publication
(10) Pub. No.: US 2023/0334700 A1
(43) Pub. Date: Oct. 19, 2023

(54) METHOD AND DEVICE FOR CALIBRATING A CAMERA, AND CAMERA

(71) Applicant: Robert Bosch GmbH, Stuttgart (DE)

(72) Inventors: Andreas Weimer, Gaertringen (DE); Farid Khani, Boennigheim (DE)

(21) Appl. No.: 18/044,523

(22) PCT Filed: Oct. 26, 2021
(86) PCT No.: PCT/EP2021/079651

§ 371 Date: Mar. 8, 2023

(30) Foreign Application Priority Data
Dec. 7, 2020 (DE) 10 2020 215 412.0

(51) Int. Cl. G06T 7/80; H04N 23/72

(52) U.S. Cl. CPC G06T 7/80; H04N 23/72

(57) ABSTRACT

A method for calibrating a camera. The method includes inputting a raw camera image, the raw camera image having a plurality of pixels, each pixel having a gray-scale value out of a plurality of gray-scale values. A first quantity of pixel gray-scale values that are above a maximum gray-scale value limit is compared with a first frequency. A current gain of the camera is adjusted to a new gain if the first quantity exceeds the first frequency. A second quantity of pixel gray-scale values that are above a minimum gray-scale value limit is compared with a second frequency if the first quantity does not exceed the first frequency. The current gain and a current exposure of the camera are retained if the second quantity is not below the second frequency. The current exposure is adjusted to a new exposure if the second quantity is below the second frequency.

### FIELD

The present invention relates to a device and method for calibrating a camera, and a camera.

### BACKGROUND INFORMATION

Most digital cameras have automatic exposure control, which adjusts either the gain or the exposure of the camera depending on the average brightness of the image. In the process, the average of a gray-scale value bar chart of the image is calculated. By way of suitable parameterization, the camera keeps the average gray-scale value in the image within a defined gray-scale value range. All the color values in the image are used to calculate the bar chart, so that the bar chart includes the spectral information in its entirety.

### SUMMARY

The present invention provides a method for calibrating a camera, a device using this method, and a camera. Advantageous developments and enhancements to the device of the present invention are possible using the measures disclosed herein.

Advantages that can be obtained using the approach of the present invention are that a camera calibration option that is particularly advantageous for detecting plants is provided. In this respect, overexposure and underexposure can be advantageously prevented.

According to the present invention, a method for calibrating a camera is provided. According to an example embodiment of the present invention, the method comprises the following steps:
inputting a raw camera image, wherein the raw camera image has a plurality of pixels, wherein each pixel has a gray-scale value out of a plurality of gray-scale values;
comparing a first quantity of pixel gray-scale values that are above a maximum gray-scale value limit with a first frequency;
adjusting a current gain of the camera to a new gain if the first quantity exceeds the first frequency;
comparing a second quantity of pixel gray-scale values that are above a minimum gray-scale value limit with a second frequency if the first quantity does not exceed the first frequency;
retaining the current gain and a current exposure of the camera if the second quantity is not below the second frequency; and
adjusting the current exposure to a new exposure if the second quantity is below the second frequency.

This method can be implemented, for example, in software or hardware or in a mixed form of software and hardware, for example in a controller or a device.

According to an example embodiment of the present invention, in the step of comparing the first quantity with the first frequency, a percentage-based comparison can be carried out. For example, the first frequency may represent an upper frequency limit for the first quantity. The upper frequency limit may, for example, specify a value of 0.1%. The new gain can thus be adjusted if more than or precisely 0.1% of the pixel gray-scale values exceed the maximum gray-scale value limit, so as to ensure better detection of plants. Alternatively, a percentage-based comparison can be carried out between the second quantity of pixel gray-scale values that are above a minimum gray-scale value limit and the second frequency. The second frequency may represent a lower frequency limit for the second quantity. The lower frequency limit may, for example, specify a value of 95%. The new exposure can thus be adjusted if less than or precisely 95% of the pixel gray-scale values exceed the minimum gray-scale value limit, so as to ensure better detection of plants. Alternatively, the current gain and the current exposure are retained. The maximum gray-scale value limit may, for example, be 4000 and/or the minimum gray-scale value limit may, for example, be 3000. The values for the maximum gray-scale value limit, the minimum gray-scale value limit, the first frequency, and/or the second frequency may be changeable as desired.

According to a specific embodiment of the present invention, the method may further comprise a comparing step in response to the step of adjusting the current gain to the new gain, wherein in the comparing step the new gain is compared with a gain threshold value, and/or a step of retaining the new gain if the new gain is not below the gain threshold value, or a step of setting the new gain at the gain threshold value and a step of adjusting the current exposure to a further new exposure if the new gain is below the gain threshold value. The gain threshold value may, for example, be 1. This can prevent the gain being less than 1.

According to an example embodiment of the present invention, the method may also comprise a comparing step in response to the step of adjusting the current exposure to the new exposure, wherein in the comparing step the further new exposure is compared with a minimum exposure threshold value, and a step of retaining the further new exposure if the further new exposure is not below the minimum exposure threshold value, or a step of setting the further new exposure at the minimum exposure threshold value if the further new exposure is below the minimum exposure threshold value. This can ensure that the exposure value does not drop below a minimum exposure threshold value.

In the step of adjusting the current exposure to the new exposure, the current exposure can be adjusted to the further new exposure using a downward correction factor. In this way, the exposure can be reduced.

According to a specific embodiment of the present invention, the method may comprise a comparing step in response to the step of adjusting the current exposure to the new exposure, wherein in the comparing step the new exposure is compared with a maximum exposure threshold value, and a step of retaining the new exposure if the new exposure does not exceed the maximum exposure threshold value, or a step of setting the new exposure at the maximum exposure threshold value and a step of adjusting the current gain to a further new gain if the new exposure exceeds the maximum exposure threshold value. This can ensure that a maximum exposure threshold value is not exceeded.

It is also advantageous if the method comprises a comparing step in response to the step of adjusting the current gain to the further new gain, wherein in the comparing step the further new gain is compared with a maximum gain threshold value, and a step of retaining the further new gain if the further new gain does not exceed the maximum gain threshold value, or a step of setting the further new gain at the maximum gain threshold value if the further new gain exceeds the maximum gain threshold value. This can ensure that the gain does not exceed a maximum gain threshold value.

By way of example, in the step of adjusting the current gain to the further new gain, the current gain is adjusted to the further new gain using an upward correction factor. In this way, the gain can be increased.

According to a specific embodiment of the present invention, the method may also comprise a step of creating a bar chart across all the gray-scale values of the pixels of the raw camera image, and a step of reading out the first quantity and the second quantity from the bar chart. The creating and reading-out steps can be carried out before the inputting step. A bar chart of this kind offers a simple way of supplying the first quantity and the second quantity.

It is also advantageous if the method comprises a step of capturing the raw camera image using an image sensor that has a plurality of red pixels for sensing the gray-scale values. The red pixels can sense/supply a mixed-light signal composed of red light and infrared light. It is advantageous to observe the red pixels since, when it comes to detecting plants, red color values and gray near-infrared color values reflected by the plants are relevant.

In the step of adjusting the current gain to the new gain, the current gain can be adjusted to the new gain using a downward correction factor, in particular wherein the downward correction factor may not exceed a value of 20%. In this way, the gain can be reduced.

In the adjusting step, the current gain can be adjusted to the new gain using the downward correction factor if a third quantity of pixel gray-scale values that are above the maximum gray-scale value limit does not exceed a maximum overexposed pixel quantity, or in a further adjusting step the current gain can be adjusted to another new gain using a maximum downward correction factor if the third quantity of pixel gray-scale values that are above the maximum gray-scale value limit exceeds the maximum overexposed pixel quantity, wherein the maximum downward correction factor downward is greater than the downward correction factor.

In the event of a particularly high number of overexposed pixels, therefore, the maximum downward correction factor can be selected so as to bring about a particularly sharp reduction in the exposure. By way of example, the maximum downward correction factor may have a value of 2 and/or the downward correction factor may have a value of 1.1.

In the step of adjusting the current exposure to the new exposure, the current exposure can be adjusted to the new exposure using an upward correction factor, in particular wherein the upward correction factor may not exceed a value of 20%. In this way, the exposure can be increased.

According to a specific embodiment of the present invention, the method may further comprise a step of generating the upward correction factor using the maximum gray-scale value limit, the minimum gray-scale value limit, and/or a third frequency of the highest gray-scale values in the raw camera image.

In this way, a correction factor can be generated that adjusts the exposure or gain to a known target value between the maximum gray-scale value limit and the minimum gray-scale value limit particularly quickly, for example directly in the next camera image. In this respect, the third frequency of the highest gray-scale values describes a variable for the percentage of the highest gray-scale values that are to be disregarded in the image. This is necessary so that outliers or noise do not lead to false results. When a third frequency of the highest gray-scale values is 5%, for example, the uppermost 5% of the highest gray-scale values are disregarded in the image.

It is also advantageous if, according to a specific embodiment of the present invention, the method further comprises a step of receiving a further raw camera image from the camera, wherein the steps of the method are carried out repeatedly in response to the receiving step using the further raw camera image. This can ensure that a plurality of raw camera images can be used to calibrate the camera.

In the receiving step, the received further raw camera image can be a subsequent raw camera image from the camera that comes directly after the raw camera image, or a subsequent raw camera image from the camera that comes after a defined sequence number. For instance, every raw camera image or, for the purpose of reducing computing power, only every xth raw camera image, for example every fifth raw camera image, may be used to calibrate the camera.

The present invention further provides a device which is configured to carry out, actuate, or implement the steps of a variant of a method disclosed herein in corresponding apparatuses. The object of the approach of the present invention can also be achieved quickly and efficiently using this variant of the approach of the present invention in the form of a device.

For this purpose, according to an example embodiment of the present invention, the device may comprise at least one arithmetic logic unit for processing signals or data, at least one storage unit for storing signals or data, at least one interface to a sensor or to an actuator for inputting sensor signals from the sensor or for outputting data or control signals to the actuator, and/or at least one communication interface for inputting or outputting data embedded in a communication protocol. The arithmetic logic unit may, for example, be a signal processor, a microcontroller, or the like, wherein the storage unit may, for example, be a flash memory, an EEPROM, or a magnetic storage unit. The communication interface can be configured to input or output data in a wireless and/or wired manner, wherein a communication interface that can input or output wired data can, for example, input said data electrically or optically from a corresponding data transmission line or output it into a corresponding data transmission line.

In the present case, a device can be construed to mean an electrical instrument that processes sensor signals and outputs control and/or data signals on that basis. The device can comprise an interface, which may be configured as hardware and/or software. When configured as hardware, the interfaces may, for example, be part of a system ASIC that includes a wide range of functions of the device. However, the interfaces may also be separate, integrated circuits or consist at least in part of discrete components. When configured as software, the interfaces may be software modules that are provided on a microcontroller in addition to other software modules, for example.

A camera comprising the above-described device and an image sensor for capturing the raw camera image is also provided according to the present invention. A camera of this kind is suited to detecting plants, it being possible to advantageously prevent overexposure and underexposure.

Exemplary embodiments of the present invention are shown in the figures and explained in greater detail in the following description.

### BRIEF DESCRIPTION OF THE DRAWINGS

FIG. 1 is a schematic illustration of a camera comprising a device for calibrating the camera and an image sensor according to an exemplary embodiment of the present invention.

FIG. 2 is a schematic illustration of a bar chart across all the gray-scale values of the pixels of a raw camera image from a camera according to an exemplary embodiment of the present invention.

FIG. 3 is a flow chart of a method for calibrating a camera according to an exemplary embodiment of the present invention.

FIG. 4 is a flow chart of a method for calibrating a camera according to an exemplary embodiment of the present invention.

FIG. 5 shows an example application of a method for calibrating a camera according to an exemplary embodiment of the present invention.

### DETAILED DESCRIPTION OF EXAMPLE EMBODIMENTS

In the following description of advantageous exemplary embodiments of the present invention, elements shown in the various figures that have a similar action are given the same or similar reference numerals and these elements are not described again.

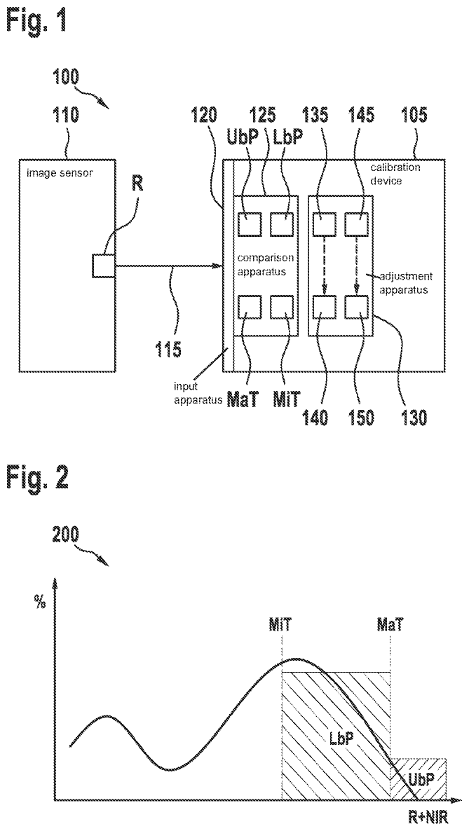

FIG. 1 is a schematic illustration of a camera 100 comprising a device 105 for calibrating the camera 100 and an image sensor 110 according to an exemplary embodiment.

The image sensor 110 is configured to capture a raw camera image 115. The device 105 has an input apparatus 120, a comparison apparatus 125, and an adjustment apparatus 130. The input apparatus 120 is configured to input the raw camera image 115, which has a plurality of pixels, wherein each pixel has a gray-scale value out of a plurality of gray-scale values. According to this exemplary embodiment, the raw camera image 115 has a plurality of red pixels R as the pixels, wherein each red pixel R has a gray-scale value out of the plurality of gray-scale values. The comparison apparatus 125 is configured to compare a first quantity of pixel gray-scale values that are above a maximum gray-scale value limit MaT with a first frequency UbP. The adjustment apparatus 130 is configured to adjust a current gain 135 of the camera 100 to a new gain 140 if the first quantity exceeds the first frequency UbP. The comparison apparatus 125 is furthermore configured to compare a second quantity of pixel gray-scale values that are above a minimum gray-scale value limit MiT with a second frequency LbP if the first quantity does not exceed the first frequency UbP. The adjustment apparatus 130 is configured to retain the current gain 135 and a current exposure 145 of the camera 100 if the second quantity is not below the second frequency LbP. In addition, the adjustment apparatus 130 is configured to adjust the current exposure 145 to a new exposure 150 if the second quantity is below the second frequency LbP. According to this exemplary embodiment, the first frequency UbP represents an upper frequency limit for the first quantity. According to this exemplary embodiment, the second frequency LbP represents a lower frequency limit for the second quantity.

According to this exemplary embodiment, values for the maximum gray-scale value limit MaT, the first frequency UbP, the minimum gray-scale value limit MiT, and/or the second frequency LbP are stored in a storage apparatus of the device 105 or can be input by the device 105.

The device 105 presented here advantageously allows for automatic exposure and gain control (AEGC) of a camera 100 in the form of a digital camera for the spectral range that is required for detecting plants.

To detect plants, cameras that can register light in the red and near-infrared spectral range are needed. Often, these cameras are used in agriculture for detecting plants. In this case, specific requirements apply in terms of automated exposure and gain control. The image sensor 110, specifically the red pixels R, are configured for sensing light in the red and near-infrared spectral range. The device 105 presented here allows for AEGC that is specifically required for detecting plants on agricultural land. In this case, the exposure is primarily increased by the device 105 before the gain, or the gain is primarily always reduced before the exposure. The noise in the image is thus always kept to a minimum.

An equally possible type of exposure control, which could be based on an average of a gray-scale value bar chart, is unsuitable for detecting plants for two reasons.

First, red and infrared light are used for detecting plants. According to this exemplary embodiment, the image sensor 110 is a normal RGB color camera in which an IR stop filter has been removed and replaced with a dual-band filter for allowing through red light and near-infrared light (NIR) and/or a green stop filter for blocking green light and/or a blue stop filter for blocking blue light. Since each pixel on the RGB camera chip is almost equally sensitive in infrared, an RGB camera becomes an ‘R+NIR, NIR, NIR’ camera. The information R+NIR is thus found in the red pixel R of the camera 100. These pixels are therefore always brighter than all the other pixels. According to this exemplary embodiment, therefore, only the red pixels R are relevant for correcting the exposure.

Second, individual plants often grow out of the ground on agricultural land. However, since plants reflect lots of NIR light and the soil absorbs lots of light, exposure cannot be controlled solely using the average. In that case, the plants would be immediately overexposed since they take up a very small amount of space in relation to the soil.

Therefore, the device 105 presented here provides suitable AEGC that is not only tailored to a new camera architecture but also particularly suitable for environmental conditions that apply for detecting plants on fields. Under no circumstances should plant objects be overexposed or underexposed, even though they take up only a fraction of the surface area in the image (often in the thousandths range).

As already described, only the red pixels R are of interest for the AEGC presented here since they include the red+NIR signal and are thus always saturated before the infrared pixel (or alternatively before the green or blue pixel). According to this exemplary embodiment, the image sensor 110 delivers raw camera images 115 in a 12-bit raw format. This is a gray-scale image in which a Bayer pattern is included, encoded as a gray-scale value. Each pixel in this image represents one color value. According to an exemplary embodiment, in response to the raw camera image 115 being input via the input apparatus 120, the device 105 generates from the raw camera image 115 a bar chart across all the gray-scale values of all the red pixels R of the raw camera image 115. A bar chart of this kind is shown in FIG. 2.

FIG. 2 is a schematic illustration of a bar chart 200 across all the gray-scale values R+NIR of the pixels of a raw camera image from a camera according to an exemplary embodiment. The raw camera image may be a raw camera image as described in FIG. 1.

According to this exemplary embodiment, the bar chart 200 shows all the gray-scale values R+NIR of the red pixels of the raw camera image.

As already described in FIG. 1, four parameters are defined in the bar chart 200:
1. A maximum gray-scale value that may occur, in the form of the maximum gray-scale value limit MaT; the gray-scale values R+NIR may not exceed this value.
2. A minimum gray-scale value that may occur, in the form of the minimum gray-scale value limit MiT; the gray-scale values R+NIR must at least reach this limit.
3. A permitted gray-scale value number (in percent) in the form of the first frequency UbP; this denotes the percentage % of pixels that may exceed the MaT limit.
4. A minimum required gray-scale value number (in percent) in the form of the second frequency LbP; this denotes the percentage % of pixels that have to exceed at least the second frequency LbP/the minimum gray-scale value limit MiT.

In this case, it is important that the first frequency UbP always takes precedence over the second frequency LbP. Thus, when the first frequency UbP is reached, the camera always executes downward control first.

Next, an example application will be described, using the following set parameters:
Maximum gray-scale value limit MaT=4000
Minimum gray-scale value limit MiT=3000
First frequency UbP=0.1%
Second frequency LbP=95%

In this case, as long as the exposure or gain is high, the device executes control until around 0.1% of the pixels in the image have reached the gray-scale value 4000 or at least 95% of the pixels have reached the gray-scale value 3000. Since the ground is always very dark in the image and occupies the largest surface area in the image, this AEGC always has a tendency to adjust the image a lot so that 95% >3000 is obtained. This is done until 0.1% of the pixels have reached the gray-scale value 4000. Since the first frequency UbP always takes precedence over the second frequency LbP, downward control is thus executed immediately. Next, the device wants to get back to 95% at 3000, so it executes upward control again. This leads to oscillation in the control between the maximum gray-scale value limit MaT and the minimum gray-scale value limit MiT. To keep the oscillation as low as possible, the device only corrects the exposure in small steps according to an exemplary embodiment.

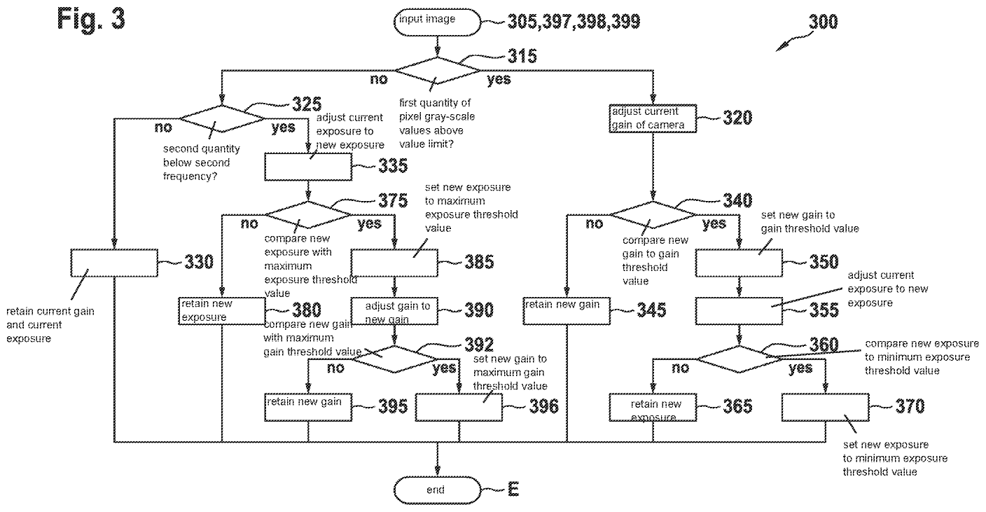

According to this exemplary embodiment, two further control parameters are stored for this purpose, which are described in more detail in FIG. 3:
an upward correction factor
a downward correction factor

Around said value, the exposure or gain is corrected upward or downward. According to an exemplary embodiment, this value is not more than 20%.

In addition, according to an exemplary embodiment, another two parameters, which define the minimum or maximum permitted exposure of the camera, are stored or can be applied, and/or, according to an exemplary embodiment, a parameter that defines the maximum permitted gain is stored or can be applied:
a maximum permitted exposure in the form of a maximum exposure threshold value
a minimum permitted exposure in the form of a minimum exposure threshold value
a maximum permitted gain in the form of a maximum gain threshold value

According to an exemplary embodiment, as a further parameter ‘Repeat,’ it is defined whether the AEGC described and presented here is applied in every raw camera image or selectively in every xth raw camera image.

The described method, which can be carried out by the device, can be used for controlling the images when detecting plants, so as to allow herbicides to be applied in a location-specific manner, for example.

FIG. 3 is a flow chart of a method 300 for calibrating a camera according to an exemplary embodiment. This method may be a method 300 that can be carried out or actuated by the device described in FIG. 1 or 2.

The method 300 comprises an inputting step 305, a step 315 of comparing a first quantity, a step 320 of adjusting a current gain, a step 325 of comparing a second quantity, a retaining step 330, and a step 335 of adjusting the current exposure.

In the inputting step 305, a raw camera image is input by the camera, wherein the raw camera image has a plurality of pixels, wherein each pixel has a gray-scale value out of a plurality of gray-scale values. In the comparing step 315, a first quantity of pixel gray-scale values that are above a maximum gray-scale value limit is compared with a first frequency. In the adjusting step 320, a current gain of the camera is adjusted to a new gain if the first quantity exceeds the first frequency. In the comparing step 325, a second quantity of pixel gray-scale values that are above a minimum gray-scale value limit is compared with a second frequency if the first quantity does not exceed the first frequency. In the retaining step 330, the current gain and a current exposure of the camera are retained if the second quantity is not below the second frequency. In the adjusting step 225, the current exposure is adjusted to a new exposure if the second quantity is below the second frequency.

According to this exemplary embodiment, in the adjusting step 320 the current gain is adjusted to the new gain using a downward correction factor, wherein, according to this exemplary embodiment, the downward correction factor does not exceed a value of 20%. According to an exemplary embodiment, the new gain is calculated by dividing the current gain by the downward correction factor.

According to this exemplary embodiment, in the adjusting step 335 the current exposure is adjusted to the new exposure using an upward correction factor, wherein, according to this exemplary embodiment, the upward correction factor does not exceed a value of 20%. According to an exemplary embodiment, the new exposure is calculated by multiplying the current exposure by the downward correction factor.

According to this exemplary embodiment, the method 300 further comprises a comparing step 340, a retaining step 345, a setting step 350, an adjusting step 355, a comparing step 360, a retaining step 365, a setting step 370, a comparing step 375, a retaining step 380, a setting step 385, an adjusting step 390, a comparing step 392, a retaining step 395, a setting step 396, a creating step 397, a capturing step 398, and/or a receiving step 399.

The comparing step 340 is executed in response to the step 320 of adjusting the current gain to the new gain, wherein in the comparing step 340 the new gain is compared with a gain threshold value, and/or in the retaining step 345 the new gain is retained if the new gain is not below the gain threshold value, or in the setting step 350 the new gain is set at the gain threshold value and in the adjusting step 355 the current exposure is adjusted to a further new exposure if the new gain is below the gain threshold value. According to an exemplary embodiment, in the comparing step 340 the new gain is compared with the gain threshold value, which is 1.

According to this exemplary embodiment, in the setting step 350 the downward correction factor is also reset by dividing the value 1 by the new gain in order to obtain a new downward correction factor.

The comparing step 360 is carried out in response to the step 355 of adjusting the current exposure to the new exposure, wherein in the comparing step 360 the further new exposure is compared with a minimum exposure threshold value, and in the retaining step 365 the further new exposure is retained if the further new exposure is not below the minimum exposure threshold value, or in the setting step 370 the further new exposure is set at the minimum exposure threshold value if the further new exposure is below the minimum exposure threshold value.

According to this exemplary embodiment, in the step 355 of adjusting the current exposure to the new exposure, the current exposure is reduced to the further new exposure using a downward correction factor. According to an exemplary embodiment, the new exposure is calculated by dividing the current exposure by the new downward correction factor.

The comparing step 375 is carried out in response to the step 335 of adjusting the current exposure to the new exposure, wherein in the comparing step 375 the new exposure is compared with a maximum exposure threshold value, and in the retaining step 380 the new exposure is retained if the new exposure does not exceed the maximum exposure threshold value, or in the setting step 385 the new exposure is set at the maximum exposure threshold value and in the adjusting step 390 the current gain is adjusted to a further new gain if the new exposure exceeds the maximum exposure threshold value.

According to this exemplary embodiment, in the setting step 385 the upward correction factor is also reset by dividing the new exposure by the maximum exposure threshold value in order to obtain a new upward correction factor. According to this exemplary embodiment, in the adjusting step 390 the current gain is adjusted to the further new gain using the new upward correction factor.

The comparing step 392 is carried out in response to the step 390 of adjusting the current gain to the further new gain, wherein in the comparing step 392 the further new gain is compared with a maximum gain threshold value, and in the retaining step 395 the further new gain is retained if the further new gain does not exceed the maximum gain threshold value, or in the setting step 396 the further new gain is set at the maximum gain threshold value if the further new gain exceeds the maximum gain threshold value.

In the creating step 397, a bar chart across all the gray-scale values of the pixels of the raw camera image is created, and in a reading-out step the first quantity and the second quantity are read out from the bar chart. According to this exemplary embodiment, the creating and reading-out steps 397 are carried out before or in response to the inputting step 305.

In the capturing step 398, the raw camera image is captured using an image sensor that has a plurality of red pixels for sensing the gray-scale values. According to this exemplary embodiment, the capturing step 398 is executed before the inputting step 305.

According to this exemplary embodiment, the steps 330, 365, 370, 380, 395, and/or 396 each lead to an end E of the method 300.

According to an exemplary embodiment, after the end E of the method 300, the method 300 further comprises the receiving step 399, in which a further raw camera image is received from the camera, wherein the steps 315, 320, 325, 330, 335, 340, 345, 350, 355, 360, 365, 370, 375, 380, 385, 390, 392, 395, 396, 397, 398 of the method 300 are carried out repeatedly in response to the receiving step 399 using the further raw camera image. According to an exemplary embodiment, the further raw camera image received in the receiving step 399 is a subsequent raw camera image from the camera that comes directly after the raw camera image, or a subsequent raw camera image from the camera that comes after a defined sequence number.

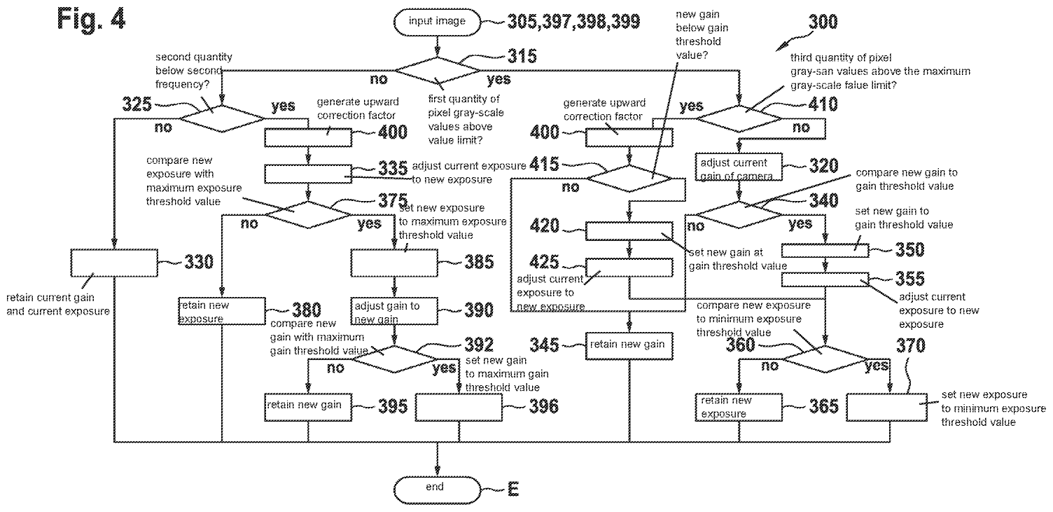

FIG. 4 is a flow chart of a method 300 for calibrating a camera according to an exemplary embodiment. This method may be the method 300 described in FIG. 3, having additional steps 400, 405, 410, 415, 420, 425 according to this exemplary embodiment.

In the generating step 400, the upward correction factor is generated using the maximum gray-scale value limit, the minimum gray-scale value limit, and/or a third frequency of the highest gray-scale values in the raw camera image. According to this exemplary embodiment, the generating step 400 is executed between the comparing step 325 and the adjusting step 335 if the second quantity is below the second frequency in the comparing step 325.

In the generating step 400, the upward correction factor (‘CfU’) is generated according to this exemplary embodiment using the following formula:

$$CfU = \frac{( maximum gray - scale value limit + minimum gray - scale value limit ) / 2}{third frequency of the highest gray - scale values in the camera image}$$

The control reaction time is considerably reduced by steps 400, 405, 410, 415, 420, 425.

The previous controller in FIG. 3 was adjusted upward and downward using the fixed correction factors. In this case, the exposure or gain of the subsequent image was in each case reduced by the downward correction factor (‘CfD’) or increased by the factor CfU. However, this has one significant drawback. The control may require up to 10 to 20 images, particularly when the weather is changeable between sunny and cloudy (typically a factor 10 in brightness), in order to arrive at the correct brightness value.

To get around this, an algorithm directly calculates the correction value CfU automatically and thus immediately sets the exposure or gain at the target value in the next image. This is possible since the algorithm knows the target value between the minimum gray-scale value limit (‘MiT’) and the maximum gray-scale value limit (‘MaT’) and the actual value, calculated from the current image.

Calculating the desired value from the current image:

The actual value is derived from the gray-scale values in the current image. In this case, it is necessary to add a new variable, namely the third frequency of the highest gray-scale values in the camera image (‘LpD,’ lower percentage denominator). This variable describes the percentage of the highest gray-scale values that are to be disregarded in the image. This is necessary so that outliers or noise cannot lead to false results. When an LpD is 5%, for example, the uppermost 5% of the highest gray-scale values are disregarded in the image. Thus, the CfU value is calculated from the following information:
CfU=Desired Value/Actual Value=((MaT+MiT)/2)/(maximum gray-scale value in the image−LpD)

According to this exemplary embodiment, in the adjusting step 320 the current gain is adjusted to the new gain using the downward correction factor if a third quantity of pixel gray-scale values that are above the maximum gray-scale value limit does not exceed a maximum overexposed pixel quantity (‘MoP’).

Alternatively, according to this exemplary embodiment, in the further adjusting step 405 the current gain is adjusted to a further new gain using a maximum downward correction factor if the third quantity of pixel gray-scale values that are above the maximum gray-scale value limit exceeds the maximum overexposed pixel quantity, wherein the maximum downward correction factor is greater than the downward correction factor. The maximum downward correction factor is also shortened to ‘CfDmax’ below.

For this purpose, according to this exemplary embodiment, after the comparing step 315, if the first quantity exceeds the first frequency, the detecting step 410 is carried out, in which it is detected whether or not the third quantity of pixel gray-scale values that are above the maximum gray-scale value limit exceeds the maximum overexposed pixel quantity.

According to this exemplary embodiment, the comparing step 415 is executed in response to the further adjusting step 405; in this comparing step, another new gain is compared with a gain threshold value, the step 345 of retaining the other new gain is executed if the other new gain is not below the gain threshold value, or the step 420 of setting the other new gain at the gain threshold value is executed and the step 425 of adjusting the current exposure to another new exposure is executed if the other new gain is below the gain threshold value. According to an exemplary embodiment, in the comparing step 415 the other new gain is compared with the gain threshold value, which is 1.

According to this exemplary embodiment, in the setting step 420 the maximum downward correction factor is also reset by dividing the value 1 by the other new gain in order to obtain a new maximum downward correction factor. According to this exemplary embodiment, the comparing step 360 is carried out in response to the step 425 of adjusting the current exposure to the other new exposure.

Determining CfD:

Unfortunately, the downward correction is not readily directly possible. In this case, there is the desired value between MaT and MiT again, but the actual value is unknown. Overexposed pixels do not contain any information as to how great the overexposure is. By way of example, it may be just 10% or even 1000%. To still allow for fast control in this case, the number of saturated pixels is calculated and a decision is made, depending on the quantity, as to whether a large or small jump has to be made in that case. For this purpose, two new variables, MoP and CfDmax, are added. Thus, in the first step the number of overexposed pixels is counted. Overexposed pixels are defined as all the pixels above MaT. If this value is above MoP, then downward control is executed using CfDmax. If not, downward control is implemented using CfD.

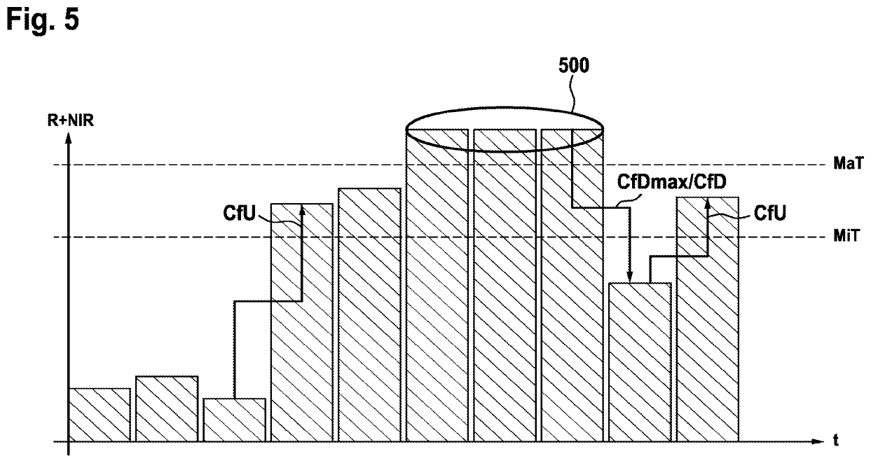

FIG. 5 shows an example application of a method for calibrating a camera according to an exemplary embodiment. The method in this case may be the method 300 described in FIG. 4.

In the example application, the following parameters are implemented according to this exemplary embodiment: MaT=3950, UbP=0.1%, MoP=0.8%, LpD=0.5%, MiT=3850, LbP=0.05%, CfDmax=2, CfD=1.1.

According to this exemplary embodiment, gray-scale values for the pixels below MiT are each adjusted up into the range between MiT and MaT using the upward correction factors CfU calculated for each pixel individually in the generating step.

According to this exemplary embodiment, gray-scale values for a quantity of pixels 500 that are overexposed above MaT by an undefined amount are adjusted down using either CfDmax or CfD depending on the quantity.

1-17. (canceled)

18. A method for calibrating a camera, comprising the following steps:
inputting a raw camera image having a plurality of pixels, wherein each of the pixels has a gray-scale value out of a plurality of gray-scale values;
comparing a first quantity of the pixel gray-scale values that are above a maximum gray-scale value limit with a first frequency;
adjusting a current gain of the camera to a new gain when the first quantity exceeds the first frequency;
comparing a second quantity of the pixel gray-scale values that are above a minimum gray-scale value limit with a second frequency when the first quantity does not exceed the first frequency;
retaining the current gain and a current exposure of the camera when the second quantity is not below the second frequency; and
adjusting the current exposure to a new exposure when the second quantity is below the second frequency.

19. The method as recited in claim 18, further comprising a comparing step in response to the adjusting of the current gain, in which the new gain is compared with a gain threshold value, and the method further comprises: (i) retaining the new gain when the new gain is not below the gain threshold value, or (ii) setting the new gain to the gain threshold value and adjusting the current exposure to a further new exposure when the new gain is below the gain threshold value.

20. The method as recited in claim 19, further comprising a comparing step in response to the adjusting of the current exposure to the further new exposure, in which the further new exposure is compared with a minimum exposure threshold value, and the method further comprises: (i) retaining the further new exposure when the further new exposure is not below the minimum exposure threshold value, or (ii) setting the further new exposure to the minimum exposure threshold value when the further new exposure is below the minimum exposure threshold value.

21. The method as recited in claim 19, wherein, in the adjusting of the current exposure to the further new exposure, the current exposure is adjusted to the further new exposure using a downward correction factor.

22. The method as recited in claim 18, further comprising a comparing step in response to the adjusting of the current exposure to the new exposure, in which the new exposure is compared with a maximum exposure threshold value, and the method further comprises: (i) retaining the new exposure when the new exposure does not exceed the maximum exposure threshold value, or (ii) setting the new exposure to the maximum exposure threshold value and adjusting the current gain to a further new gain when the new exposure exceeds the maximum exposure threshold value.

23. The method as recited in claim 22, comprising a comparing step in response to the adjusting of the current gain to the further new gain, in which the further new gain is compared with a maximum gain threshold value, and the method further includes: (i) retaining the further new gain when the further new gain does not exceed the maximum gain threshold value, or (ii) setting the further new gain to the maximum gain threshold value when the further new gain exceeds the maximum gain threshold value.

24. The method as recited in claim 22, wherein, in the adjusting of the current gain to the further new gain, the current gain is adjusted to the further new gain using a second upward correction factor.

25. The method as recited in claim 18, further comprising:
creating a bar chart across all of the gray-scale values of the pixels of the raw camera image; and
reading out the first quantity and the second quantity from the bar chart.

26. The method as recited in claim 18, further comprising:
capturing the raw camera image using an image sensor that has a plurality of red pixels for sensing the gray-scale values.

27. The method as recited in claim 18, wherein in the adjusting of the current gain to the new gain, the current gain is adjusted to the new gain using a downward correction factor, the downward correction factor not exceeding a value of 20%.

28. The method as recited in claim 27, wherein the adjusting of the current gain to the new gain, the current gain is adjusted to the new gain using the downward correction factor when a third quantity of pixel gray-scale values that are above the maximum gray-scale value limit does not exceed a maximum overexposed pixel quantity, or in a further adjusting step, the current gain is adjusted to another new gain using a maximum downward correction factor when the third quantity of pixel gray-scale values that are above the maximum gray-scale value limit exceeds the maximum overexposed pixel quantity, wherein the maximum downward correction factor is greater than the downward correction factor.

29. The method as recited in claim 18, wherein in the adjusting of the current exposure to the new exposure, the current exposure is adjusted to the new exposure using an upward correction factor, wherein the upward correction factor does not exceed a value of 20%.

30. The method as recited in claim 29, further comprising generating the upward correction factor using the maximum gray-scale value limit, and/or the minimum gray-scale value limit, and/or a third frequency of the highest gray-scale values in the raw camera image.

31. The method as recited in claim 18, further comprising:
receiving a further raw camera image from the camera, wherein the steps of the method are carried out repeatedly in response to the receiving step, using the further raw camera image.

32. The method as recited in claim 31, wherein the further raw camera image received in the receiving step is a subsequent raw camera image from the camera that comes directly after the raw camera image, or a subsequent raw camera image from the camera that comes after a defined sequence number.

33. A device configured to calibrate a camera, the device configured to:
input a raw camera image having a plurality of pixels, wherein each of the pixels has a gray-scale value out of a plurality of gray-scale values;
compare a first quantity of the pixel gray-scale values that are above a maximum gray-scale value limit with a first frequency;
adjust a current gain of the camera to a new gain when the first quantity exceeds the first frequency;
compare a second quantity of the pixel gray-scale values that are above a minimum gray-scale value limit with a second frequency when the first quantity does not exceed the first frequency;
retain the current gain and a current exposure of the camera when the second quantity is not below the second frequency; and
adjust the current exposure to a new exposure when the second quantity is below the second frequency.

34. A camera, comprising:
an image sensor configured to capture a raw camera image; and
a device configured to calibrate the camera, the device configured to:
input the raw camera image, the raw camera image having a plurality of pixels, wherein each of the pixels has a gray-scale value out of a plurality of gray-scale values;
compare a first quantity of the pixel gray-scale values that are above a maximum gray-scale value limit with a first frequency;
adjust a current gain of the camera to a new gain when the first quantity exceeds the first frequency;
compare a second quantity of the pixel gray-scale values that are above a minimum gray-scale value limit with a second frequency when the first quantity does not exceed the first frequency;
retain the current gain and a current exposure of the camera when the second quantity is not below the second frequency; and
adjust the current exposure to a new exposure when the second quantity is below the second frequency.
